(19) United States
(12) Patent Application Publication
(10) Pub. No.: US 2002/0130174 A1
(43) Pub. Date: Sep. 19, 2002

(54) System and method of conducting commercial retail transactions without the need of using a currency's lowest value coins

(76) Inventor: James L. Smith, Englewood, OH (US)

Correspondence Address: R. William Graham, 22 S. St. Clair St., Dayton, OH, 45402, US

(21) Appl. No.: 10/037,418

(22) Filed: Nov. 9, 2001

Related U.S. Application Data
(60) Provisional application No. 60/262,777, filed on Jan. 20, 2001.

(51) Int. Cl. G06F 17/60

(52) U.S. Cl. 235/379

(57) ABSTRACT

A system and method for eliminating the need of using a currency system's lowest value coins in an automated commercial retail transaction includes employing a currency system in an automated commercial retail transaction, wherein the currency system includes a plurality of different valued coins having a first coin of a first lower predetermined value and a second coin of a higher predetermined value and wherein said retail commercial transaction is of a value at least equal to said value of said second coin and employing a computer in said automated commercial transaction having means for tallying a customer's amount of the transaction and rounding said customer's amount to a nearest multiple of said second coin to produce an adjusted amount, whereby a customer can pay said adjusted amount.

This is a continuation-in-part of U.S. Ser. No. 60/262,777 filed Jan. 20, 2001.

### FIELD OF THE INVENTION

This invention relates to electronic commercial retail transactions. More particularly, the invention is directed to a system and method of conducting cash-payment transactions within a particular monetary system, such as the United States, without the need to exchange pennies, or, in another country, without the need to exchange the lowest value coins of that monetary system's currency.

### BACKGROUND OF THE INVENTION

Presently, there are many millions of dollars worth of coins, or change, estimated to be lying around and not being used in most currency systems. For example, in the U.S. currency system, the lowest form of currency exchange is in the form of pennies. Pennies commonly make a one-way trip from a merchant or a bank to the home where the pennies end up in jars or on dresser tops, get lost, or are simply discarded; people see pennies on the ground but can't be bothered to pick them up, and they throw away pennies into fountains and wishing wells. Thus, occasional penny shortages occur in commerce which causes the U.S. mint to produce ever more pennies, many of which will likewise end up being lost, hoarded, or thrown away.

U.S. Pat. No. 5,869,826 to Eleftheriou (1999) discloses a system and method for eliminating the need for all coins in commercial transactions that includes a customer owned magnetic stripe data card used for storing and updating that customer's ongoing change balance amount in lieu of using coins, and a merchant owned magnetic stripe change balance data card reader/writer. Because the value (the current change balance amount) stored on the magnetic stripe data card is a small amount ranging from 0 to 99 cents, and because that ever-changing value is not readily discernible to the customer at any given point in time, the card system has an inherent deficiency which is likely to be viewed as a nuisance and not likely to be readily acceptable.

Human nature being what it is, many customers will without fail show up at a checkout cashier position without their Eleftheriou system change balance card, it having been lost, stolen, or simply forgotten at home or in the car; or ‘the wife has it’ or ‘the husband has it’, etc. In this situation the customer and the merchant will not be able to conduct their business in the promised efficient and timely manner since the customer will then need to acquire a new magnetic stripe data card, or use coins in his possession, or receive coins in change by paying the next higher whole dollar amount.

Merchants will therefore see little or no advantage in making an investment in a system and method for replacing coins while at the same time having to maintain out of necessity a supply of coins, and the expense of purchasing or manufacturing an initial supply and frequent replacement orders of magnetic stripe change balance data cards will be prohibitive. Customers will be able to use their magnetic stripe data card at participating merchants yet will still find it necessary to exchange coins at the many thousands of merchants who will choose not to participate in the Eleftheriou system. It is likely that thousands of individuals could easily end up owning two or three or more magnetic stripe data cards, each with a different and unknown change balance, thus defeating their intended purpose and it is highly unlikely that a quantity of these accumulated Eleftheriou magnetic stripe change balance data cards could ever be bundled and exchanged for paper bill currency at a local bank, as can coins.

Since neither merchant nor customer can rely solely on the use of the Eleftheriou magnetic stripe change balance data card, it is apparent that coins of minimum common denominator values will remain useful in our current monetary system of commerce and thus Eleftheriou's magnetic stripe change balance card system and method has few if any advantages.

With this said, the wide disdain the public now has for coins, pennies in particular, presages a vast public appetite for conducting business transactions without exchanging pennies.

### SUMMARY OF THE INVENTION

An object and advantage of the present invention is to provide a system and method for conducting an automated commercial transaction that does not require the exchange of lowest value coins between a merchant and a customer.

Another object is to provide a method for conducting an automated commercial transaction which offers the merchant a cash management tool for use during a penny shortage, and a tool that, if widely used, provides a deterrent to a future penny shortage.

Still another object is to provide a method for conducting an automated commercial transaction that rounds a customer's final total, thus allowing a merchant continued wide use of 0.97, 0.98, and 0.99 cents (etc.) price-endings on individual items.

Yet another object is to provide a method for conducting an automated commercial transaction which requires no overt action from a cashier or a customer, and which provides equity, over time, to both merchant and customer.

An additional object provides a system for conducting an automated commercial transaction which requires no merchant investment in add-on equipment, such as a supply of magnetic stripe change-balance cards and an associated change-balance card reader/writer, and which mitigates the ordering, receiving, handling, sorting, counting and storing of pennies.

Accordingly, the present invention is directed to a method of conducting an automated commercial transaction without the need for using a currency's lowest common denominator, such as U.S. pennies (or another currency's lowest value coin) by rounding the transaction total up or down to a multiple of the next highest common denominator of such currency. For example, in the U.S. currency system, the method includes the steps of reducing a customer's total-amount-due to a nearest whole five-cent multiple when the hundredth's position of the cents-portion of the total-amount-due is 1, 2, 6 or 7 and increasing a customer's total-amount-due to a nearest whole five-cent multiple when the hundredth's position of the cents-portion of the total-amount-due is 3, 4, 8 or 9.

Additional objects and advantages will become apparent from a consideration of the ensuing description and the accompanying drawings.

### BRIEF DESCRIPTION OF THE DRAWING

FIG. 1 is a diagram of a computer system employing the present invention showing exemplary current-visit customer purchase information therein; and

FIG. 2 is a block flow diagram of a preferred embodiment for practicing the invention.

### Reference Numerals

5 system for conducting an automated commercial transaction without the need for using a currency's system lowest valued coin

| | | | |
|---|---|---|---|
| 10 | host computer system | 12 | updatable memory |
| 14 | customer purchases database | 16 | total amount due |
| 20 | step one | 22 | step two |
| 24 | step three | 26 | step four |

### Description of Abbreviations in Drawings

Q—Quotient: a number resulting from a mathematical division;

TAD—Total Amount Due: a customer's total-amount-due stored in a computer memory;

RQ—Rounded Quotient: a whole number quotient without a fractional portion;

NTD—New Total Amount Due: a customer's new rounded (and pennyless) total-amount-due owed to a merchant.

### DETAILED DESCRIPTION OF THE PREFERRED EMBODIMENT

Referring now to the drawings of the present invention, the system for conducting an automated commercial transaction without the need for using a currency's system lowest valued coin is generally referred to by the numeral 5. The chosen embodiment of the present invention includes computer software code which can be preferably inserted into existing computer software code executing within a host computer system, such as an electronic point-of-sale (POS) retail terminal.

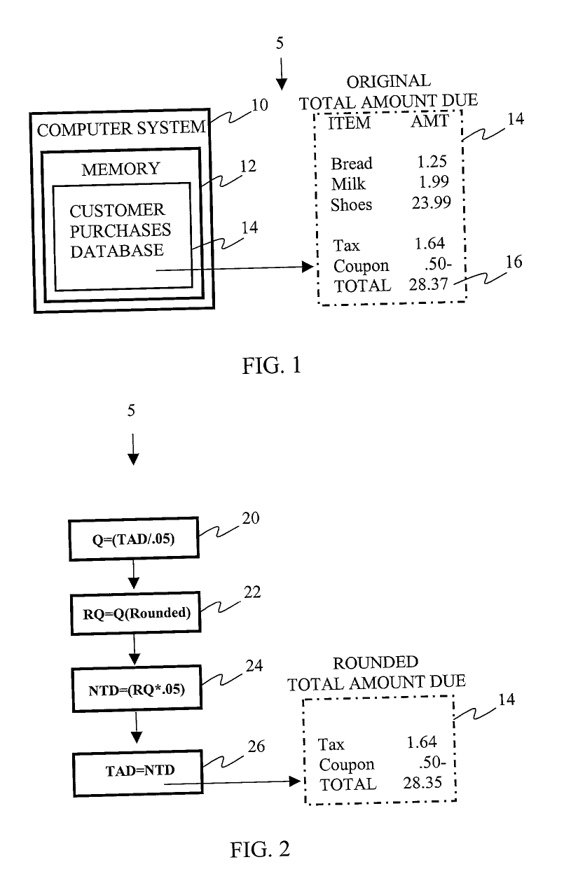

FIG. 1 shows a host computer system 10. In the computer system 10 includes an updatable memory 12. Storably disposed in the updatable memory 12 is a customer purchases database 14 containing current-visit customer purchase information, here itemized goods including for example, bread, milk and shoes. In a conventional approach, the purchase information database 14 concludes with a total-amount-due (TAD) 16 that includes any applicable taxes and excludes any discount and/or coupon savings.

### Preferred Embodiment - Operation

In operation, a customer's previously calculated total-amount-due (TAD) 16 is rounded by the present invention up or down to the nearest whole five-cent multiple, thereby to change any cents-amount ending in 1, 2, 3, 4, 6, 7, 8, or 9 to a cents-amount ending in 0 or 5.

FIG. 2 illustrates a preferred approach of the present invention, and is shown in four steps: step one 20; step two 22; step three 24; and step four 26.

First, in step one 20, a customer's total-amount-due (TAD) 16 is divided by 0.05 resulting in a quotient (Q). Said quotient (Q) may or may not have a fractional portion. For example, the customer's total-amount-due shown in FIG. 1 (28.37) divided by 0.05 is 567.4.

Next, in step two 22, any fractional portion of the quotient (Q) is rounded to the nearest whole number (RQ). (Done properly, 0.2 and 0.4 will always round down, while 0.6 and 0.8 will always round up.) Continuing the example, 567.4 rounded to the nearest whole number is 567.

Thirdly, in step three 24, the whole number quotient (RQ) is multiplied by 0.05 to calculate a new rounded total-amount-due (NTD). Staying with the ongoing example, 567 times 0.05 is 28.35.

Finally, in step four 26, the new rounded total-amount-due (NTD) replaces the original total-amount-due (TAD) 16 and the customer is asked to pay an amount that does not require the exchange of pennies. Concluding the example, the customer will be asked to pay 28.35 instead of 28.37.

Four steps are indicated for ease of explanation, yet in many computer programming languages one skilled in the relevant art might easily combine steps one 20, two 22, three 24, and four 26 into just one or two steps, commands, or instructions. It will also be apparent to one skilled in the relevant art that the present invention may be used in various types of computer systems, including, but not limited to, a point-of-sale (POS) terminal.

The preferred embodiment of the present invention is described herein in terms of United States currency for convenience purposes only. It would be readily apparent to one having ordinary skill in the relevant art how to develop and use a comparable system using the currency equivalents of another country.

Accordingly it is seen that, according to the invention, a method is provided that will eliminate the need to exchange pennies (or the lowest value coin of another currency) during a commercial transaction, a method that, if widely used, can help avoid a future penny shortage, that allows a merchant to continue current pricing strategies on individual items, that requires no active participation of the cashier or the customer, that provides equity, over time, to both merchant and customer, that requires no merchant investment in add-on hardware, and that lessens the nuisance of ordering, receiving, handling, sorting, counting, and storing pennies.

Although the preceding description contains specificity as to the mathematical steps employed, these should not be construed as limiting the scope of the invention but as merely providing an illustration of the presently preferred embodiment of the invention. Various other embodiments and ramifications are possible within it's scope.

For example, rounding to the nearest whole five-cent multiple can also be accomplished by examining the rightmost digit of the cents-amount of the total-amount-due and adding pennies to or subtracting pennies from the total-amount-due, as follows:

Step 1. If the rightmost digit of the cents-amount is 1 or 6, subtract 0.01 from the existing total-amount-due, then exit.

Step 2. If the rightmost digit of the cents-amount is 2 or 7, subtract 0.02 from the existing total-amount-due, then exit.

Step 3. If the rightmost digit of the cents-amount is 3 or 8, add 0.02 to the existing total-amount-due, then exit.

Step 4. If the rightmost digit of the cents-amount is 4 or 9, add 0.01 to the existing total-amount-due, then exit.

Thus the scope of the invention should be determined by the appended claims and their normal equivalents, rather than by the examples given.

What is claimed is:

1. A method for eliminating the need of using a currency system's lowest value coins in an automated commercial retail transaction, including the steps of:
(A) employing a currency system in an automated commercial retail transaction, wherein the currency system includes a plurality of different valued coins having a first coin of a first lower predetermined value and a second coin of a higher predetermined value and wherein said retail commercial transaction is of a value at least equal to said value of said second coin; and
(B) employing a computer in said automated commercial transaction having means for tallying a customer's amount of the transaction and rounding said customer's amount to a nearest multiple of said second coin to produce an adjusted amount, whereby a customer can pay said adjusted amount.

2. The method of claim 1, wherein said second coin is a multiple of said first coin.

3. The method of claim 2, wherein said first coin includes a penny and said second coin includes a nickel.

4. The method of claim 1, wherein the step of rounding is performed to change said customer's amount ending in 1, 2, 3, 4, 6, 7, 8, or 9 to said adjusted amount ending in 0 or 5.

5. The method of claim 1, wherein said rounding occurs by dividing said customer amount by said value of said second coin to obtain a modified number, rounding any remaining fractional amount of said modified number to obtain a nearest whole number and multiplying said whole number by said value of said second coin to obtain said adjusted amount.

6. The method of claim 1, which further includes the step of displaying said adjusted amount.

7. The method of claim 6, which further includes the step of printing said adjusted amount.

8. A method for eliminating the need of using a currency's lowest value coins in an automated commercial retail transaction, including the steps of:
(A) employing a computer in an automated commercial retail transaction, said computer having means for tallying a customer's amount of the transaction and rounding said customer's amount to a nearest multiple of a predetermined coin having a predetermined value to produce an adjusted amount, whereby a customer can pay said adjusted amount; and
(B) performing said tallying and said rounding in said transaction and displaying said adjusted amount.

9. The method of claim 8, which includes the step of printing said adjusted amount.

10. The method of claim 8, wherein said predetermined coin includes a nickel.

11. The method of claim 8, wherein the step of rounding is performed to change said customer amount ending in 1, 2, 3, 4, 6, 7, 8, or 9 to said adjusted amount ending in 0 or 5.

12. The method of claim 8, wherein said rounding occurs by dividing said customer amount by said predetermined value to obtain a modified number, rounding any remaining fractional amount of said modified number to obtain a nearest whole number and multiplying said whole number by said predetermined value to obtain said adjusted amount.

13. An electronic data processor for conducting a commercial transaction without the need for using a currency system's lowest valued coin by causing the transaction to be rounded to a value which is a multiple of a higher valued coin, including:
a computer based device having software therein for performing automated commercial retail transaction, said computer software having means for tallying a customer's amount of the transaction as a multiple of a lowest valued coin in the system and rounding said customer's amount to a nearest multiple of a predetermined higher valued coin in the currency system to produce an adjusted amount, whereby a customer can pay said adjusted amount; and
means operably associated with said computer based device for displaying said adjusted amount.

14. The electronic data processor of claim 13, wherein said lowest valued coin includes a penny and said higher valued coin includes a nickel.

15. The electronic data processor of claim 13, which includes means for printing said adjusted amount.
